(19) United States
(12) Patent Application Publication
(10) Pub. No.: US 2024/0132790 A1
(43) Pub. Date: Apr. 25, 2024

(54) PROCESS FOR PRODUCING JET FUEL WITH HEAT INTEGRATION

(71) Applicant: UOP LLC, Des Plaines, IL (US)

(72) Inventors: Neeraj Tiwari, Gurgaon (IN); James T. Wexler, Wheaton, IL (US); Marina S. Minin, Lake Forest, IL (US)

(21) Appl. No.: 18/371,890

(22) Filed: Sep. 21, 2023

Related U.S. Application Data
(60) Provisional application No. 63/418,020, filed on Oct. 20, 2022.

(51) Int. Cl. C10G 65/12

(52) U.S. Cl. CPC C10G 65/12; C10G 2300/4081

(57) ABSTRACT

A process isolates a liquid hydrocracked stream from a liquid hydroisomerized stream, so heat in the hydrocracked stream can be preserved. Preserving heat in the hydrocracked stream avoids having to reheat the hydrocracked stream before product fractionation. Particularly, kerosene in the hydrocracked stream is not cooled with the hydroisomerized stream and then reheated in fractionation to distill the kerosene range hydrocarbons from the diesel range hydrocarbons.

### FIELD

The field is producing hydrocarbons useful as aviation fuel from a hydrocarbon feedstock. Particularly, the field may relate to producing aviation fuel from renewable feedstocks such as triglycerides and free fatty acids found in materials such as plant and animal fats and oils.

### BACKGROUND

As the demand for fuel increases worldwide, there is increasing interest in producing fuels and blending components from sources other than crude oil. Often referred to as a biorenewable source, these sources include, but are not limited to, plant oils such as corn, rapeseed, canola, soybean, microbial oils such as algal oils, animal fats such as inedible tallow, fish oils and various waste streams such as yellow and brown greases and sewage sludge. A common feature of these sources is that they are composed of glycerides and free fatty acids (FFA). Both triglycerides and the FFAs contain aliphatic carbon chains having from about 8 to about 24 carbon atoms. The aliphatic carbon chains in triglycerides or FFAs can be fully saturated or mono, di or poly-unsaturated.

Hydroprocessing can include processes which convert hydrocarbons in the presence of hydroprocessing catalyst and hydrogen to more valuable products. Hydrotreating or hydrogenation is a process in which hydrogen is contacted with hydrocarbons in the presence of hydrotreating catalysts which are primarily active for the removal of heteroatoms, such as sulfur, nitrogen, oxygen and metals from the hydrocarbon feedstock. In hydrotreating, hydrocarbons with double and triple bonds such as olefins may be saturated.

The production of hydrocarbon products in the diesel boiling range can be achieved by hydrotreating a biorenewable feedstock. A biorenewable feedstock can be hydroprocessed by hydrotreating to deoxygenate, decarboxylate and/or decarbonylate the oxygenated hydrocarbons. Decarboxylation and decarbonylation remove a carbon from the paraffin molecule; whereas, deoxygenation does not. Hydrotreating may be followed by hydroisomerization to improve cold flow properties of product diesel and jet fuel. Hydroisomerization or hydrodewaxing is a hydroprocessing process that increases the alkyl branching on a hydrocarbon backbone in the presence of hydrogen and hydroisomerization catalyst to improve cold flow properties of the hydrocarbon. Hydroisomerization includes hydrodewaxing herein.

Hydrocracking is a hydroprocessing process in which hydrocarbons crack in the presence of hydrogen and hydrocracking catalyst to lower molecular weight hydrocarbons. Depending on the desired output, a hydrocracking unit may contain one or more beds of the same or different catalyst.

When producing jet fuel from triglycerides (also referred to as “fats”) a certain degree of hydrocracking and isomerization is needed to meet the specifications of jet fuel as outlined in ASTM D7566 Annex 2 and ASTM D1655. These key specifications that are required of the jet fuel in D7566 are freeze point of not higher than −40° C. (ASTM D5972, D7153 or D7154), density of no more than 772 kg/m³ (ASTM D1298 or D4052), T10 of less than 205° C. (ASTM D86), and a final boiling point (FBP) of less than 300° C. (ASTM D86). Larger molecules that do not meet these jet fuel specifications are hydrocracked primarily to meet these specifications which inherently results in low yield in the production process and in a low energy-density fuel which is undesirable. Aviation fuel is valued for its high energy per volume.

Carbon intensity is a term that refers to moles of carbon dioxide produced to make a mole of fuel. Combustion of hydrocarbons such as to heat hydrocarbons streams in a hydroprocessing unit increases carbon intensity. It would be desirable to provide a renewable fuel from a process that reduces carbon intensity by reducing heating requirements.

### SUMMARY

We have found that all the reactor charge stream preheating can be achieved by heat exchange with the hydrotreated effluent stream from the hydrotreating reactor. As a result, fired charge heaters can be omitted resulting in reduced capital and operational expenditures as well as reduction in carbon intensity due to the absence of hydrocarbon combustion to provide enthalpy.

### BRIEF DESCRIPTION OF THE DRAWINGS

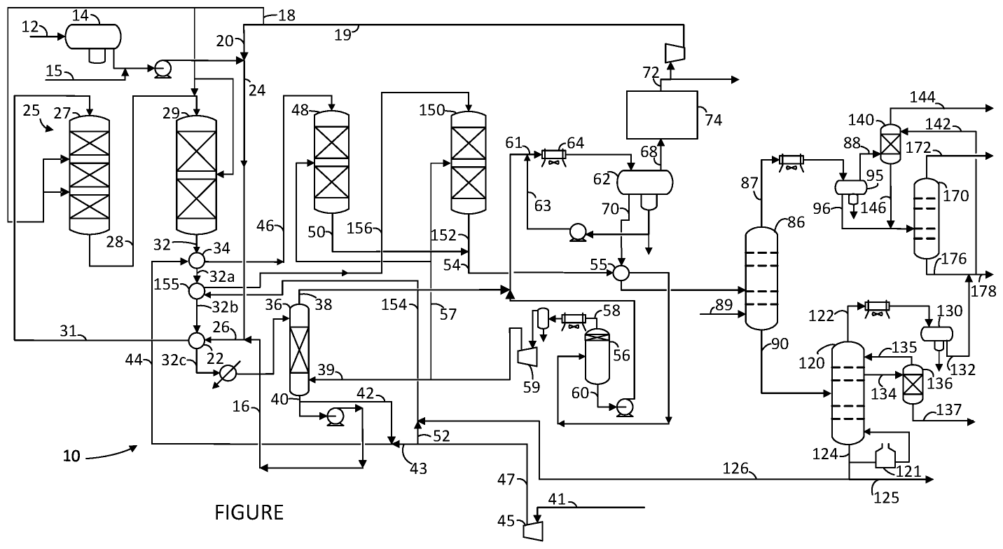

The FIG. 1 is a schematic process flow diagram of the present disclosure.

### DEFINITIONS

The term “communication” means that material flow is operatively permitted between enumerated components.

The term “downstream communication” means that at least a portion of material flowing to the subject in downstream communication may operatively flow from the object with which it communicates.

The term “upstream communication” means that at least a portion of the material flowing from the subject in upstream communication may operatively flow to the object with which it communicates.

The term “direct communication” means that flow from the upstream component enters the downstream component without passing through a fractionation or conversion unit to undergo a compositional change due to physical fractionation or chemical conversion.

The term “indirect communication” means that flow from the upstream component enters the downstream component after passing through a fractionation or conversion unit to undergo a compositional change due to physical fractionation or chemical conversion.

The term “bypass” means that the object is out of downstream communication with a bypassing subject at least to the extent of bypassing.

The term “column” means a distillation column or columns for separating one or more components of different volatilities. Unless otherwise indicated, each column includes a condenser on an overhead of the column to condense and reflux a portion of an overhead stream back to the top of the column and a reboiler at a bottom of the column to vaporize and send a portion of a bottoms stream back to the bottom of the column. Feeds to the columns may be preheated. The top pressure is the pressure of the overhead vapor at the vapor outlet of the column. The bottom temperature is the liquid bottom outlet temperature. Overhead lines and bottoms lines refer to the net lines from the column downstream of any reflux or reboil to the column. Stripper columns may omit a reboiler at a bottom of the column and instead provide heating requirements and separation impetus from a fluidized inert media such as steam. Stripping columns typically feed a top tray and take main product from the bottom.

As used herein, the term “a component-rich stream” means that the rich stream coming out of a vessel has a greater concentration of the component than the feed to the vessel.

As used herein, the term “a component-lean stream” means that the lean stream coming out of a vessel has a smaller concentration of the component than the feed to the vessel.

As used herein, the term “boiling point temperature” means atmospheric equivalent boiling point (AEBP) as calculated from the observed boiling temperature and the distillation pressure, as calculated using the equations furnished in ASTM D86 or ASTM D2887.

As used herein, the term “True Boiling Point” (TBP) means a test method for determining the boiling point of a material which corresponds to ASTM D-2892 for the production of a liquefied gas, distillate fractions, and residuum of standardized quality on which analytical data can be obtained, and the determination of yields of the above fractions by both mass and volume from which a graph of temperature versus mass % distilled is produced using fifteen theoretical plates in a column with a 5:1 reflux ratio.

As used herein, the term “T5” or “T95” means the temperature at which 5 mass percent or 95 mass percent, as the case may be, respectively, of the sample boils using ASTM D-86 or TBP.

As used herein, the term “initial boiling point” (IBP) means the temperature at which the sample begins to boil using ASTM D2887, ASTM D-86 or TBP, as the case may be.

As used herein, the term “final boiling point” (FBP) means the temperature at which the sample has all boiled off using ASTM D2887, ASTM D-86 or TBP, as the case may be.

As used herein, the term “diesel boiling range” means hydrocarbons boiling in the range of an IBP between about 125° C. (257° F.) and about 175° C. (347° F.) or a T5 between about 150° C. (302° F.) and about 200° C. (392° F.) and the “diesel cut point” comprising a T95 between about 343° C. (650° F.) and about 399° C. (750° F.) using the TBP distillation method.

As used herein, the term “diesel conversion” means conversion of feed that boils above the diesel cut point to material that boils at or below the diesel cut point in the diesel boiling range.

As used herein, the term “separator” means a vessel which has an inlet and at least an overhead vapor outlet and a bottoms liquid outlet and may also have an aqueous stream outlet from a boot. A flash drum is a type of separator which may be in downstream communication with a separator that may be operated at higher pressure.

As used herein, the term “predominant” or “predominate” means greater than 50%, suitably greater than 75% and preferably greater than 90%.

As used herein, the term “Cₓ” are to be understood to refer to molecules having the number of carbon atoms represented by the subscript “x”. Similarly, the term “Cₓ” refers to molecules that contain less than or equal to x and preferably x and less carbon atoms. The term “Cₓ+” refers to molecules with more than or equal to x and preferably x and more carbon atoms.

As used herein, the term “carbon number” refers to the number of carbon atoms per hydrocarbon molecule and typically a paraffin molecule.

### DETAILED DESCRIPTION

We have found that all the charge heating requirements in a diesel and jet fuel production process can be provided by the hydrotreated effluent stream. Particularly, hydrodeoxygenation of oxygenated hydrocarbons from glyceride molecules obtained from renewable biorenewable feeds provide ample heating requirements for charge streams for a hydrotreating reactor, a hydroisomerization reactor and even a hydrocracking reactor if employed.

In the FIGURE, in accordance with an exemplary embodiment, a process 10 is shown for processing a hydrocarbon feedstock. Preferably, the hydrocarbon feedstock is a biorenewable hydrocarbon feedstock. A feed line 12 transports a hydrocarbon stream of fresh, preferably, biorenewable feedstock into a feed surge drum 14. The biorenewable feedstock may be blended with a mineral feed stream but preferably comprises a predominance or all of a biorenewable feedstock. A mineral feedstock is a conventional feed derived from crude oil that is extracted from the ground. The biorenewable feedstock may comprise a nitrogen concentration of about 1 wppm to about 2000 wppm. The biorenewable feedstock may comprise high oxygen content which can be up to 10 wt % or higher. The biorenewable feedstock may also comprise about 1 to about 500 wppm sulfur, typically no more than about 200 wppm sulfur.

A variety of different biorenewable feedstocks may be suitable for the process 10. The term “biorenewable feedstock” is meant to include feedstocks other than those obtained from crude oil. The biorenewable feedstock may include any of those feedstocks which comprise at least one of glycerides and free fatty acids. Most of glycerides will be triglycerides, but monoglycerides and diglycerides may be present and processed as well. Free fatty acids may be obtained from phospholipids which may source phosphorous in the feedstock. Examples of these biorenewable feedstocks include, but are not limited to, camelina oil, canola oil, corn oil, soy oil, rapeseed oil, soybean oil, colza oil, tall oil, sunflower oil, hempseed oil, olive oil, linseed oil, coconut oil, babassu oil, castor oil, peanut oil, palm oil, mustard oil, tallow, yellow and brown greases, lard, train oil, fats in milk, fish oil, algal oil, sewage sludge, and the like. Additional examples of biorenewable feedstocks include non-edible vegetable oils from the group comprising Jatropha curcas (Ratanjot, Wild Castor, Jangli Erandi), Madhuca indica (Mohuwa), Pongamia pinnata (Karanji, Honge), Calophyllum inophyllum, Moringa oleifera and Azadirachta indica (Neem). The triglycerides and FFAs of the typical vegetable or animal fat contain aliphatic hydrocarbon chains in their structure which have about 8 to about 30 carbon atoms. Biorenewable feedstocks may also include biomass pyrolysis oils and Fischer-Tropsch waxes. As will be appreciated, the biorenewable feedstock may comprise a mixture of one or more of the foregoing examples. The biorenewable feedstock may be pretreated to remove contaminants and filtered to remove solids.

The hydrocarbon stream in feed line 12 flows from the feed surge drum 14 via a charge pump perhaps after injection with a sulfiding agent in line 15 and mixes with a recycle hydrotreating hydrogen stream in a hydrotreating hydrogen line 20 to provide a combined hydrocarbon stream in line 24. The combined hydrocarbon stream in line 24 is mixed with a hydrotreating recycle stream in a recycle line 16 to provide a hydrotreating charge hydrocarbon stream in a hydrotreating charge line 26. The recycle to feed rate can be about 1:1 to about 5:1. The hydrotreating charge stream in line 26 may be preheated in a hydrotreating charge exchanger 22 by heat exchange with a twice cooled hydrotreated stream in a twice cooled hydrotreated line 32b. The heated hydrotreating charge hydrocarbon stream in the hydrotreating charge line 26 may be then charged to a hydrotreating reactor 25. The heat exchange in the hydrotreating charge exchanger 22 with the twice cooled hydrotreated stream provides all of the preheating requirements necessary for the hydrotreating reactor 25. Heat exchange with the hydrotreated stream is sufficient; no fired heater is required to bring the hydrotreating charge stream in line 26 to hydrotreating reaction temperature. The hydrotreating charge stream is only heated by indirect heat exchange with other uncombusted streams.

The hydrotreating reactor 25 may include a guard bed reactor 27. The guard bed reaction temperature may range between about 246° C. (475° F.) and about 343° C. (650° F.) and suitably between about 288° C. (550° F.) and about 304° C. (580° F.). The guard bed reactor 27 is operated low enough to prevent olefins in the FFA from polymerizing but high enough to foster olefin saturation, hydrodemetallation, hydrodeoxygenation, hydrodesulfurization and hydrodenitrification reactions to occur. Hydrodeoxygenation reactions preferably minimize hydrodecarbonylation and hydrodecarboxylation reactions to preserve carbon atoms on the paraffin chain.

The guard bed reactor 27 can comprise 1 to 5 beds of guard catalyst. In the FIGURE, the guard bed reactor 27 comprises three beds of guard catalyst. The guard bed catalyst can comprise a base metal catalyst on a support. Base metals useable in this process include non-noble metals, nickel, chromium, molybdenum and tungsten. Other base metals that can be used include tin, indium, germanium, lead, cobalt, gallium and zinc. The process can also use a metal sulfide, wherein the metal in the metal sulfide is selected from one or more of the base metals listed. The hydrotreating charge stream can be charged through the base metal catalysts at pressures from 1379 kPa (abs) (200 psia) to 13790 kPa (abs) (2000 psia). In a further embodiment, the guard bed catalyst can comprise a second metal, wherein the second metal includes one or more of the metals: tin, indium, ruthenium, rhodium, rhenium, osmium, iridium, germanium, lead, cobalt, gallium, zinc and thallium. A nickel molybdenum on alumina catalyst may be a suitable catalyst in the guard bed reactor 27. Suitable guard catalyst includes BGB 300 available from UOP LLC in Des Plaines, Illinois. Although a guard bed reactor 27 is shown in the FIGURE, one or more guard beds may be contained in a single hydrotreating reactor such as 2, 3 or more. A hydrogen quench from a hydrogen manifold 18 taken from a recycle hydrogen stream in line 19 may be injected at interbed locations to control temperature exotherms.

A contacted hydrocarbon stream is discharged from the guard bed reactor 27 in line 28. In the guard bed reactor 27, most of the hydrodemetallation and hydrodeoxygenation reactions will occur with some hydrodenitrogenation and hydrodesulfurization occurring. Metals removed from biorenewable feedstocks will include alkali metals and alkali earth metals and phosphorous. The contacted hydrocarbon stream will discharge from the guard bed reactor 27 in line 28, receive a hydrogen quench from hydrogen manifold 18 and enter into a hydrogenation reactor 29.

The hydrotreating reactor 25 also includes the hydrogenation reactor 29. In the hydrogenation reactor 29, the contacted hydrocarbon stream is contacted with a hydrotreating catalyst in the presence of hydrogen at hydrotreating conditions to saturate the olefinic or unsaturated portions of the n-paraffinic chains in the feedstock. The hydrotreating catalyst also catalyzes hydrodeoxygenation reactions, including hydrodecarboxylation and hydrodecarbonylation reactions, to remove oxygenate functional groups from the hydrocarbon molecules in the biorenewable feedstock which are converted to water and carbon oxides. The hydrotreating catalyst also catalyzes hydrodesulfurization of organic sulfur and hydrodenitrogenation of organic nitrogen in the biorenewable feedstock. Essentially, the hydrotreating reaction removes heteroatoms from the hydrocarbons and saturates olefins in the feed stream.

The hydrotreating catalyst may be provided in one, two or more beds in a single or multiple vessels and employ interbed hydrogen quench streams from the hydrogen quench stream. Recycle hydrogen quench streams taken from the recycle hydrogen line 19 in the hydrogen manifold line 18 may be provided for interbed quench to the hydrotreating reactor 29. Two hydrotreating catalyst beds 29 are shown in FIG. 1, but one or more are contemplated.

The hydrotreating catalyst may comprise nickel, nickel/molybdenum, or cobalt/molybdenum dispersed on a high surface area support such as alumina. Other catalysts include one or more noble metals dispersed on a high surface area support. Non-limiting examples of noble metals include platinum and/or palladium dispersed on an alumina support such as gamma-alumina. Suitable hydrotreating catalysts include BDO 200 or BDO 300 or BDO 400 available from UOP LLC in Des Plaines, Illinois. The hydrotreating reaction temperature may range from between about 271° C. (520° F.) and about 427° C. (800° F.) and preferably between about 304° C. (580° F.) and about 400° C. (752° F.). Generally, hydrotreating conditions include a pressure of about 700 kPa (100 psig) to about 21 MPa (3000 psig).

A hydrotreated stream is produced in a hydrotreated line 32 from the hydrogenation reactor 29 in the hydrotreating reactor 25 comprising a hydrocarbon fraction which has a substantial n-paraffin concentration. Oxygenate concentration in the hydrocarbon fraction is essentially nil, whereas the olefin concentration is substantially reduced relative to the contacted stream. The organic sulfur concentration in the hydrocarbon fraction may be no more than 500 wppm and the organic nitrogen concentration in the hydrocarbon fraction may be less than 10 wppm.

The reactions occurring in the hydrotreating reactor 25 are highly exothermic, so the enthalpy in the hydrotreated stream 32 exiting the hydrotreating reactor 25 is very great, providing an opportunity for heat transfer particularly to reactor charge streams.

The hydrotreated stream in the hydrotreated line 32 may first flow to the combined isomerization feed exchanger 34 to heat the hydroisomerization charge stream in the hydroisomerization charge line 44 to provide a heated hydroisomerization charge stream in a heated hydroisomerization charge line 46 and cool the hydrotreated stream to provide a once cooled hydrotreated stream in line 32a by indirect heat exchange. The once-cooled hydrotreated stream in the hydrotreated line 32a may then be heat exchanged with the combined hydrocracking charge stream in a combined hydrocracking charge line 154 in the hydrocracking effluent charge heat exchanger 155 to heat the combined hydrocracking charge stream in the combined hydrocracking charge line 154 to provide a heated hydrocracking charge stream in the heated hydrocracking charge line 156 and further cool the once cooled hydrotreated stream in the hydrotreated line 32a to provide a twice-cooled hydrotreated stream in line 32b. The twice-cooled hydrotreated stream in the hydrotreated line 32b may then be heat exchanged with the combined hydrocarbon stream in line 26 as previously stated in the combined feed heat exchanger 22 to further cool the twice-cooled hydrotreated stream in the hydrotreated line 32b to provide a thrice-cooled hydrotreated stream in the hydrotreated line 32c and heat the hydrotreating charge stream to provide the heated hydrotreating charge stream in the hydrotreated line 31. The thrice cooled hydrotreated steam in the hydrotreated line 32 may be then further cooled, perhaps to make steam, before it is separated. Sufficient heat is present in the hydrotreated stream in line 32 to heat all of the reactor charge streams 44, 154 and 26. The reactor charge streams in lines 44, 154 and 26 may be further heated by heat exchange to increase their temperature or to help increase their temperature to reaction temperature, but intense heating such as in a fired heater in which hydrocarbons are combusted is not necessary to achieve reaction temperature. The charge streams are only heated by indirect heat exchange with other uncombusted streams.

The hydroisomerization charge stream in line 44 is heated by heat exchange with the hydrotreated stream in line 32 before said hydrocracking charge stream in line 154 is heated by heat exchange with said hydrotreated stream in line 32a with regard to flow direction of the hydrotreated stream 32. Moreover, the hydrocracking charge stream in line 154 is heated by heat exchange with the hydrotreated stream in line 32a before said hydrotreating charge stream is heated by heat exchange with said hydrotreated stream in line 32b with regard to flow direction of the hydrotreated stream.

The cooled hydrotreated stream may be separated in a hydrotreating separator 36 which may comprise an enhanced hot separator (EHS) with the aid of a stripping gas fed in a stripping line 39 taken from an isomerization overhead line 58. The hydrotreated stream is separated to provide a hydrotreated vapor stream in a hydrotreated overhead line 38 and a hydrotreated liquid stream in a hydrotreated bottoms line 40 having a smaller oxygen concentration than the hydrotreating charge stream in line 26. The hydrotreating separator 36 may be a high-pressure stripping column. In the hydrotreating separator 36, the hydrotreated stream from the hydrotreated line 32 flows down through the column where it is partially stripped of hydrogen, carbon dioxide, carbon monoxide, water vapor, propane, hydrogen sulfide, and phosphine, which are potential hydroisomerization catalyst poisons, by contact with stripping gas from the stripping line 39. The stripping gas may comprise makeup hydrogen gas which has passed through the isomerization reactor 48 and the hydrocracking reactor 150 and an hydroprocessing separator 56 as hereinafter described.

The stripping gas in the stripping line 39 enters the hydrotreating separator 36 below the inlet for the hydrotreated stream in the hydrotreated line 32. The hydrotreating separator 36 may include internals such as trays or packing located between the inlet for the hydrotreated stream in line 32 and the inlet for the stripping gas in the stripping line 39 to facilitate stripping of the hydrotreated stream. The stripping gas including stripped gases exit in a hydrotreated vapor stream in the hydrotreated overhead line 38 extending from a top of the hydrotreating separator 36 with an hydroisomerization liquid stream in an hydroisomerization bottoms line 60, mixes with a cold aqueous stream in a cold aqueous line 63 from a boot of a cold separator 62 is cooled in a cooler 64 and enters a cold separator 62.

The hydrotreating separator 36 operates at about 177° C. (350° F.) to about 371° C. (700° F.) and preferably operates at about 204° C. (400° F.) to about 260° C. (500° F.). The hydrotreating separator 36 may be operated at a slightly lower pressure than the hydrotreating reactor 25 accounting for pressure drop through intervening equipment. The hydrotreating separator 36 may be operated at pressures between about 3.4 MPa (gauge) (493 psig) and about 20.4 MPa (gauge) (2959 psig). The hydrotreated vapor stream in the hydrotreating separator overhead line 38 may have a temperature of the operating temperature of the hydrotreating separator 36.

The hydrotreated liquid stream which may have been stripped collects in the bottom of the hydrotreating separator 36 and flows in a hydrotreated bottoms line 40. The liquid hydrotreated stream comprises diesel range material, with a high paraffinic concentration if the hydrocarbon feed comprises a biorenewable feedstock. The liquid hydrotreated stream in the hydrotreating separator bottoms line 40 may be split into two streams: a hydroisomerization charge stream taken in a hydroisomerization charge line 42 and the recycle hydrotreated stream taken in the recycle line 16 both taken from the liquid hydrotreated stream in the hydrotreated bottoms line 40. The recycle hydrotreated stream in the recycle line 16 may be pumped and combined with the combined hydrocarbon stream in line 24 to provide the hydrotreating charge stream in the hydrotreating charge line 26 as previously described.

While a desired product, such as a transportation fuel, may be provided in the hydrotreated bottoms line 40 because the liquid hydrotreated stream comprises a higher concentration of normal paraffins, it will possess poor cold flow properties and a high FBP disqualifying it from meeting jet fuel specifications. Accordingly, to improve the cold flow properties and reduce its FBP, the hydrotreated liquid stream may be hydroisomerized.

Make-up hydrogen gas in make-up line 41 may be compressed in a make-up gas compressor 45 to provide compressed make up gas in a compressed make-up gas header 47. A hydroisomerization make-up gas stream is taken from the make-up gas header 47 in line 43 and mixed with the hydroisomerization charge stream in line 42 to provide a combined hydroisomerization charge stream in the combined hydroisomerization charge line 44. The combined hydroisomerization charge stream in the combined hydroisomerization charge line 44 may be heated in an hydroisomerization feed exchanger 34 by heat exchange with the hydrotreated stream in the hydrotreated line 32 as previously described to bring the combined hydroisomerization charge stream to hydroisomerization temperature before charging the combined hydroisomerization charge stream to the hydroisomerization reactor 48. Heat exchange with the hydrotreated stream is sufficient; no fired heater is required to bring the hydroisomerization charge stream in line 44 to hydroisomerization reaction temperature. However, heat exchange may be employed to bring the combined hydroisomerization charge stream in the combined hydroisomerization charge line 44 to reaction temperature upstream of the heat exchange with the hydrotreated stream in line 32 in the combined hydroisomerization feed exchanger 34. For example, the combined hydroisomerization charge stream in the combined hydroisomerization charge line 44 may be heat exchanged with the hydroisomerized stream in the hydroisomerized line 50 to preheat the combined hydroisomerization charge stream in the hydroisomerization charge line 44 upstream of the combined isomerization feed exchanger 34. The hydroisomerization charge stream is only heated by indirect heat exchange with other uncombusted streams.

Hydroisomerization, including hydrodewaxing, of the normal hydrocarbons in the hydroisomerization reactor 48 can be accomplished over one or more beds of hydroisomerization catalyst, and the hydroisomerization may be operated in a co-current mode of operation. Fixed bed, trickle bed down-flow or fixed bed liquid filled up-flow modes are both suitable.

The hydroisomerization catalyst comprises a dehydrogenation metal, a molecular sieve and a metal oxide binder. The hydroisomerization catalyst may comprise a dehydrogenation metal comprising a Group VIII metal. The dehydrogenation metal(s) may be selected from platinum, palladium, nickel, nickel molybdenum sulfide or nickel tungsten sulfide. Preferably, the dehydrogenation metal is selected from platinum or nickel tungsten sulfide. The concentration of dehydrogenation metal on the hydroisomerization catalyst may comprise from 0.05 to 5 wt % based on the transition metal(s).

The dehydrogenation metal is distributed between the molecular sieve and the binder with about 40 to about 65 wt %, preferably 45 to about 60 wt %, of the metals distributed on the molecular sieve and about 40 to about 65 wt %, preferably 45 to about 60 wt %, of the metals distributed on the binder. The associated benefit of the hydroisomerization catalyst is high activity and selectivity toward hydroisomerization. In a further embodiment the hydroisomerization catalyst further comprises less than about 0.5 wt % carbon with the associated benefit of high activity and selectivity towards hydroisomerization.

In an embodiment, the hydroisomerization catalyst comprises one or more molecular sieves having a topology selected from AEI, AEL, AFO, AFX, ATO, BEA, CHA, FAU, FER, MEL, MFI, MOR, MRE, MTT, MWW or TON, such as EU-2, ZSM-11, ZSM-22, ZSM-23, ZSM-48, SAPO-5, SAPO-11, SAPO-31, SAPO-34, SAPO-41, SSZ-13, SSZ-16, SSZ-39, MCM-22, zeolite Y, ferrierite, mordenite, ZSM-5 or zeolite beta, with the associated benefit of the molecular sieve being active in the hydroisomerization of linear hydrocarbons.

The metal oxide binder may be taken from the group comprising alumina, silica, silica-alumina and titanic or mixtures thereof. Preferably the metal oxide binder is alumina and preferably it is gamma alumina.

The hydroisomerization catalyst typically comprises particles having a diameter of about 1 to about 5 millimeters. The catalyst production typically involves the formation of a stable, porous support, followed by impregnation of active metals. The stable, porous support typically comprises a metal oxide as well as a molecular sieve, which may be a zeolite. The stable support is produced with a high porosity, to ensure maximum surface area, and it is typically desired to disperse the active metal over the full internal and external surface area of the support. DI-200 available from UOP LLC in Des Plaines, Illinois may be a suitable hydroisomerization catalyst.

Hydroisomerization conditions generally include a temperature of about 150° C. (302° F.) to about 450° C. (842° F.) and a pressure of about 1724 kPa (abs) (250 psia) to about 13.8 MPa (abs) (2000 psia). In another embodiment, the hydroisomerization conditions include a temperature of about 300° C. (572° F.) to about 388° C. (730° F.), a pressure of about 3102 kPa (abs) (450 psia) to about 13790 kPa (abs) (2000 psia), a LHSV of about 0.5 to 3 hr⁻¹ and a hydrogen rate of about 337 Nm³/m³ (2,000 scf/bbl) to about 2,527 Nm³/m³ oil (15,000 scf/bbl). Hydroisomerization quench gas can be taken from the quench gas manifold 57 can be provided to the hydroisomerization reactor 48 at an interbed location.

A hydroisomerized stream in a hydroisomerized line 50 from the hydroisomerization reactor 48 is a branched-paraffin-rich stream. Preferably the hydroisomerized stream is predominantly a branched paraffin stream. It is envisioned that the hydroisomerized effluent may contain 80, 90 or 95 mass-% branched paraffins of the total paraffin content. Hydroisomerization conditions in the hydroisomerization reactor 48 are selected to avoid undesirable cracking, so the predominant product in the hydroisomerized stream in the hydroisomerized line 50 is a branched paraffin. By avoiding undesirable cracking, the hydroisomerized stream in the hydroisomerized line 50 will have near and only slightly less of the same composition with regard to carbon numbers as the hydroisomerization feed stream in the hydroisomerization charge line 42. The optimal amount of remaining normal paraffins in line 50 is dependent on the selectivity of the hydroisomerization catalysts but might typically be between 1-7 wt-%.

The hydroisomerized stream in the hydroisomerized line 50 from the hydroisomerization reactor 48 may be mixed with the hydrocracked stream in line 152 to provide a mixed hydroprocessed stream in line 54. The mixed hydroprocessed stream in line 54 may be further cooled in a cold liquid exchanger 55 by heat exchange with the cold separator bottom stream in line 70 and fed to the hydroprocessing separator 56 for separation into a liquid hydroprocessed stream and vapor hydroprocessed stream. An internal packing may be located in the top of the hydroprocessing separator 56 to ensure liquid components are inhibited from leaving in a hydroprocessing overhead line 58. The vapor hydroprocessed stream in the hydroprocessed overhead line 58 extending from an overhead of hydroprocessing separator 56 may be cooled, fed to a drum to knock off condensate and compressed in the compressor 59 to provide the stripping gas in the stripping line 39 for the hydrotreating separator 36 and the quench gas in the quench gas manifold 57.

In an embodiment, the liquid hydroprocessed stream in the hydroprocessed bottoms line 60 extending from a bottom of the hydroprocessing separator 56 may be pumped to the cold separator 62 to be further separated along with the vaporous hydrotreated stream in line 38 and the cold aqueous stream in the cold aqueous in line 63 pumped around from the boot of the cold separator 62. The cold aqueous stream in line 63 may be combined with the vaporous hydrotreated stream in line 38 and the liquid hydroprocessed stream in line 60 to provide a cooler hydroprocessed stream in line 61. The cooler hydroprocessed stream in line 61 may be cooled in a cooler 64 and fed to the cold separator 62. The cold aqueous stream in the cold aqueous line 63 is added to the liquid hydroprocessed stream and the vaporous hydrotreated stream to dissolve salts that may be present in the liquid hydrocarbon in the cold separator 62.

In the cold separator 62, vaporous components in the hydroprocessed liquid stream and the vaporous hydrotreated stream will separate and ascend to provide a cold vapor hydroprocessed stream in a cold overhead line 68 and a liquid hydroprocessed stream in a cold bottoms line 70 and the cold aqueous stream taken in a cold aqueous line 63 from the boot. Some of the cold aqueous stream from the boot may be taken to water treatment. The cold vaporous hydroprocessed steam in the cold overhead line 68 may be scrubbed to remove acid gases in the scrubber 74 to provide a scrubbed hydrogen stream in line 72. The scrubbed hydrogen stream in line 72 may be split between a recycle hydrogen stream in line 19 and a purge gas stream. The recycle hydrogen stream in line 19 is compressed in a recycle gas compressor and recycled to the hydrotreating reactor 25 in the manifold line 18 for interbed quench and the hydrotreating hydrogen line 20 for combination with the hydrocarbon stream in the feed line 12.

Liquid fuel components in the liquid hydroprocessed stream and the vapor hydrotreated stream will exit the cold separator in the cold hydroisomerized bottoms line 70. The stripper liquid hydroisomerized stream in cold hydroprocessed bottoms line 70 comprises diesel and jet boiling range fuels as well as other hydrocarbons such as propane and naphtha.

In an embodiment, the cold liquid hydroprocessed stream in the cold bottoms line 70 may be stripped in a stripping column 86 to remove hydrogen sulfide and other gases. The stripper liquid hydroprocessed stream in the cold bottoms line 70 may be heated by heat exchange in the cold liquid exchanger 55 with the hydroprocessed stream in the hydroprocessed line 54 to cool the hydroprocessed stream and heat the cold liquid hydroprocessed stream and fed to the stripping column 86.

A stripping media which is an inert gas such as steam from a stripping media line 89 may be used to strip light gases from the stripper liquid hydroisomerized stream in line 70. The stripping column 86 provides an overhead stripping stream of naphtha, LPG, hydrogen, hydrogen sulfide, steam and other gases in a stripper overhead line 87 and a fractionator hydroisomerized stream in a stripped bottoms line 90. The overhead stripping stream in the overhead line 87 may be condensed by cooling and separated in a stripping receiver 95. A net stripper overhead line 88 from the receiver 95 may carry a net stripper overhead stream to a sponge absorber 140. Unstabilized liquid naphtha from the bottoms of the receiver 95 may be transported in a stripper receiver bottoms line 96 to a debutanizer column 170 for naphtha and LPG recovery. A sour water stream may be collected from a boot of the overhead receiver 95.

The stripping column 86 may be operated with an overhead pressure of about 0.35 MPa (gauge) (50 psig), preferably no less than about 0.70 MPa (gauge) (100 psig), to no more than about 2.0 MPa (gauge) (290 psig). The temperature in the overhead receiver 95 ranges from about 38° C. (100° F.) to about 66° C. (150° F.) and the pressure is essentially the same as in the overhead of the stripping column 86.

The stripped hydroprocessed stream in the stripper bottoms line 90 may be heated and fed to the product fractionation column 120 to provide fractionated products. A diesel stream in a bottoms line 124 is taken from a bottom of the product fractionation column 120. A hydrocracking charge stream in line 126 may be taken from the diesel stream in the bottoms line 124 from the product fractionation column 120. The product fractionation column 120 may be reboiled by heat exchange with a suitable hot stream or in a fired heater 121 to provide the necessary heat for the distillation. Alternately, a stripping media which is an inert gas such as steam from a stripping media line may be used to heat the column. A reboil stream is taken to the fired heater 121 and returned boiling to the product fractionation column 120. A diesel product stream may be taken in a diesel product line 125 to a diesel pool and may be green diesel. The diesel stream in the distillation bottoms line 124 may be a diesel stream having a T5 of about 230° C. (446° F.) to about 296° C. (590° F.) and a T90 of about 343° C. (650° F.) to about 399° C. (750° F.).

The product fractionation column 120 provides an overhead gaseous stream of naphtha in an overhead line 122. The fractionation overhead stream may be completely condensed and separated from water in a fractionation receiver 130. Unstabilized liquid naphtha from the bottom of the receiver 130 in a fractionator overhead liquid line 132 may combined with a naphtha stream in line 176. A sour water stream may be collected from a boot of the distillation receiver 130.

A kerosene stream may be taken from the side of the product fractionation column 120 in a side line 134. The kerosene stream taken in the side line 134 may be stripped in a kerosene stripper column 136 to drive off lower boiling materials which are returned back to the product fractionation column 120 at a higher elevation in an overhead kerosene line 135. A stripped bottoms kerosene stream is produced in a bottoms kerosene line 137 to provide a jet fuel product stream. The jet fuel product stream in line 137 meets jet fuel specifications per ASTM D86 and may be a green jet fuel stream taken from a bottom of the kerosene stripper column 136. The jet fuel product stream in line 137 may be cooled and transported to the jet fuel pool.

Optionally a light diesel stream may be taken in a second side line and stripped in a side diesel stripper that is not shown.

The product fractionation column 120 may be operated with a bottoms temperature between about 149° C. (300° F.) and about 288° C. (550° F.), preferably no more than about 260° C. (500° F.), and an overhead pressure of about 0.35 MPa (gauge) (50 psig), preferably no less than about 0.70 MPa (gauge) (100 psig), to no more than about 2.0 MPa (gauge) (290 psig). The temperature in the overhead receiver 130 ranges from about 38° C. (100° F.) to about 66° C. (150° F.) and the pressure is essentially the same as in the overhead of the product fractionation column 120. It is also envisioned that the product fractionation column 120 may just provide a net overhead stream comprising jet fuel in the fractionator overhead liquid line 132, with naphtha and lighter stream taken in the fractionator receiver net overhead line (not shown).

The overhead stripping stream of naphtha, LPG, hydrogen, hydrogen sulfide, steam and other gases in the stripper net overhead line 88 may be optionally scrubbed to remove acid gases and passed to the sponge absorber column 140 for hydrocarbon recovery.

The sponge absorber column 140 may receive the hydrocarbon-rich stream in the stripper net overhead line 88. A lean absorbent stream in a lean absorbent line 142 may be fed into the sponge absorber column 140 through an absorbent inlet. The lean absorbent may comprise a naphtha stream in a lean absorbent line 142 perhaps from the debutanizer bottoms stream in line 176. In the sponge absorber column 140, the lean absorbent stream and the scrubbed hydrocarbon-rich stream are counter-currently contacted. The sponge absorbent absorbs LPG hydrocarbons from the net stripper gaseous stream into an absorbent rich stream.

The hydrocarbons absorbed by the sponge absorbent include some methane and ethane and most of the LPG, C₃ and C₄, hydrocarbons, and any C₅ and C₆₊ light naphtha hydrocarbons in the net stripper gaseous stream. The sponge absorber column 140 operates at a temperature of about 34° C. (93° F.) to about 60° C. (140° F.) and a pressure essentially the same as or lower than the off-gas scrubbing column 140 less frictional losses. A sponge absorption off gas stream depleted of LPG hydrocarbons is withdrawn from a top of the sponge absorber column 140 at an overhead outlet through a sponge absorber overhead line 144. The sponge absorption off gas stream in the sponge absorber overhead line 144 may be transported to a fuel gas header that is not shown for providing fuel gas needs. A rich absorbent stream rich in LPG hydrocarbons is withdrawn in a rich absorber bottoms line 146 from a bottom of the sponge absorber column 140 at a bottoms outlet which may be fed to the debutanizer column 170 via the stripper overhead liquid stream in the stripper receiver bottoms line 96.

In an embodiment, the debutanizer column 170 may fractionate the stripper liquid overhead stream in line 96 and the rich absorbent stream in the rich absorber bottoms line 146 into a debutanized bottoms stream comprising predominantly C₅₊ hydrocarbons and a debutanizer overhead stream comprising LPG hydrocarbons. The debutanizer overhead stream in a debutanizer overhead line 172 may provide recovery of LPG in a debutanized overhead liquid stream. The debutanized bottoms stream may be withdrawn from a bottom of the debutanizer column 170 in the debutanized bottoms line 176. A debutanized bottoms stream in line 176 comprising naphtha may be supplemented with liquid naphtha from the bottom of the receiver 130 in the fractionator overhead liquid line 132 and split between the lean absorbent stream in the lean absorbent line 142 and a product naphtha stream which is cooled and forwarded to a gasoline pool in line 178.

The fractionation bottoms stream in the fractionation bottoms line 124 may comprise diesel boiling range hydrocarbons. In an embodiment the jet fuel stream in the line 137 and the diesel stream in line 125 may be taken once through, with no recycle. The cut point in the product fractionation column 120 between the diesel stream in the bottoms line 124 and the jet fuel stream in the side line 134 can be adjusted to ensure that the jet fuel stream has the appropriate composition to meet jet fuel specifications, at least after blending, particularly to meet the jet fuel density specification. However, because the larger paraffins are concentrated in the fractionation bottoms stream it is well suited for hydrocracking to kerosene range hydrocarbons.

In an optional embodiment, the hydrocracking charge stream in the hydrocracking charge line 126 may be charged to the hydrocracking reactor 150. The hydrocracking reactor 150 is downstream of the hydroisomerization reactor 48 and the hydrotreating reactor 25. The hydrocracking charge stream may be mixed with a hydrocracking hydrogen stream in line 52 taken from the compressed make-up hydrogen stream in compressed make-up gas header 47 to provide combined hydrocracking charge stream in a combined hydrocracking charge line 154. The combined hydrocracking charge stream may be heated by heat exchange with the once cooled hydrotreated stream in line 32a in the hydrocracking effluent charge exchanger 155 to provide the twice cooled hydrotreated stream in line 32b and the heated hydrocracking charge stream in the heated hydrocracking chare line 156 that is charged to the hydrocracking reactor 150. The heat exchange in the hydrocracking effluent charge exchanger 155 as previously described is sufficient to bring the combined hydrocracking charge stream to hydrocracking reaction temperature before charging the combined hydrocracking charge stream to the hydrocracking reactor 150. Heat exchange with the hydrotreated stream is sufficient; no fired heater is required to bring the hydrocracking charge stream in line 154 to hydrocracking reaction temperature. However, heat exchange may be employed to bring the combined hydrocracking charge stream in the combined hydrocracking charge line 154 to reaction temperature upstream of the heat exchange with the once cooled hydrotreated stream in line 32a in the hydrocracking effluent charge exchanger 155. For example, the combined hydrocracking charge stream in the combined hydrocracking charge line 44 may be heat exchanged with the hydrocracked stream in the hydrocracked line 152 to preheat the combined hydrocracking charge stream in the hydrocracking charge line 154 upstream of the hydrocracking effluent charge exchanger 155. The hydrocracking charge stream is only heated by indirect heat exchange with other uncombusted streams.

The hydrocracking reactor 150 may be a fixed bed reactor that comprises one or more vessels, single or multiple catalyst beds in each vessel, and various combinations of hydrocracking catalyst in one or more vessels. The hydrocracking reactor 150 may be operated in a conventional continuous gas phase, a moving bed or a fluidized bed hydroprocessing reactor.

The combined hydrocracking stream is hydrocracked over a hydrocracking catalyst in the hydrocracking reactor 150 in the presence of a hydrocracking hydrogen stream from a hydrocracking hydrogen line 52 to provide a hydrocracked stream. Quench gas taken from the quench gas manifold 57 can be provided to the hydrocracking reactor 150 at an interbed location.

The hydrocracking reactor may provide a total conversion of at least about 20 vol % and typically greater than about 60 vol % of the hydrocracking charge stream in the heated hydrocracking charge line 156 to products boiling below the heavy diesel range of about 293° C. (560° F.) to about 310° C. (590° F.). The hydrocracking reactor 150 may operate at partial conversion of more than about 30 vol % or full conversion of at least about 90 vol % of the feed based on total conversion. The hydrocracking reactor 150 may be operated at mild hydrocracking conditions which will provide about 20 to about 60 vol %, preferably about 20 to about 50 vol %, total conversion of the hydrocracking charge stream to product boiling below the heavy diesel boiling range.

The hydrocracking catalyst may utilize amorphous silica-alumina bases or zeolite bases combined with one or more Group VIII or Group VIB metal hydrogenating components to selectively produce a balance of light diesel and jet fuel distillate. In another aspect, a catalyst which comprises, in general, any crystalline zeolite cracking base upon which is deposited a Group VIII metal hydrogenating component may be suitable. Additional hydrogenating components may be selected from Group VIB for incorporation with the zeolite base. Moreover, the hydroisomerization catalyst from the hydroisomerization reactor 48 can be used as hydrocracking catalyst in the hydrocracking reactor 150 but run at the high end of the hydroisomerization temperature range.

The zeolite cracking bases are sometimes referred to in the art as molecular sieves and are usually composed of silica, alumina and one or more exchangeable cations such as sodium, magnesium, calcium, rare earth metals, etc. They are further characterized by crystal pores of relatively uniform diameter between about 4 and about 14 Angstroms. It is preferred to employ zeolites having a relatively high silica/alumina mole ratio between about 3 and about 12. Suitable zeolites found in nature include, for example, mordenite, stilbite, heulandite, ferrierite, dachiardite, chabazite, erionite and faujasite. Suitable synthetic zeolites include, for example, the B, X, Y and L crystal types, e.g., synthetic faujasite and mordenite. The preferred zeolites are those having crystal pore diameters between about 8 and 12 Angstroms, wherein the silica/alumina mole ratio is about 4 to 6. One example of a zeolite falling in the preferred group is synthetic Y molecular sieve.

The natural occurring zeolites are normally found in a sodium form, an alkaline earth metal form, or mixed forms. The synthetic zeolites are nearly always prepared in the sodium form. In any case, for use as a cracking base it is preferred that most or all of the original zeolitic monovalent metals be ion-exchanged with a polyvalent metal and/or with an ammonium salt followed by heating to decompose the ammonium ions associated with the zeolite, leaving in their place hydrogen ions and/or exchange sites which have actually been decationized by further removal of water. Hydrogen or “decationized” Y zeolites of this nature are more particularly described in U.S. Pat. No. 3,100,006.

Mixed polyvalent metal-hydrogen zeolites may be prepared by ion-exchanging with an ammonium salt, then partially back exchanging with a polyvalent metal salt and then calcining. In some cases, as in the case of synthetic mordenite, the hydrogen forms can be prepared by direct acid treatment of the alkali metal zeolites. In one aspect, the preferred cracking bases are those which are at least about 10 wt %, and preferably at least about 20 wt %, metal-cation-deficient, based on the initial ion-exchange capacity. In another aspect, a desirable and stable class of zeolites is one wherein at least about 20 wt % of the ion exchange capacity is satisfied by hydrogen ions.

The active metals employed in the preferred hydrocracking catalysts of the present disclosure as hydrogenation components are those of Group VIII, i.e., iron, cobalt, nickel, ruthenium, rhodium, palladium, osmium, iridium and platinum. In addition to these metals, other promoters may also be employed in conjunction therewith, including the metals of Group VIB, e.g., molybdenum and tungsten. The amount of hydrogenating metal in the catalyst can vary within wide ranges. Broadly speaking, any amount between about 0.05 wt % and about 30 wt % may be used. In the case of the noble metals, it is normally preferred to use about 0.05 to about 2 wt % noble metal. Noble metals may be preferred as the hydrogenation metal on the hydrocracking catalyst to provide selectivity to jet fuel due to the absence of hydrogen sulfide and ammonia which can deactivate noble metal catalysts, but which have been removed upstream in the process.

The method for incorporating the hydrogenation metal is to contact the base material with an aqueous solution of a suitable compound of the desired metal wherein the metal is present in a cationic form. Following addition of the selected hydrogenation metal or metals, the resulting catalyst powder is then filtered, dried, pelleted with added lubricants, binders or the like if desired, and calcined in air at temperatures of, e.g., about 371° C. (700° F.) to about 648° C. (200° F.) in order to activate the catalyst and decompose ammonium ions. Alternatively, the base component may be pelleted, followed by the addition of the hydrogenation component and activation by calcining.

The foregoing catalysts may be employed in undiluted form, or the powdered catalyst may be mixed and copelleted with other relatively less active catalysts, diluents or binders such as alumina, silica gel, silica-alumina cogels, activated clays and the like in proportions ranging between about 5 and about 90 wt %. These diluents may be employed as such, or they may contain a minor proportion of an added hydrogenating metal such as a Group VIB and/or Group VIII metal. Additional metal promoted hydrocracking catalysts may also be utilized in the process of the present disclosure which comprises, for example, aluminophosphate molecular sieves, crystalline chromosilicates and other crystalline silicates. Crystalline chromosilicates are more fully described in U.S. Pat. No. 4,363,178.

By one approach, the hydrocracking conditions may include a temperature from about 290° C. (550° F.) to about 468° C. (875° F.), preferably 300° C. (572° F.) to about 445° C. (833° F.), a pressure from about 2.7 MPa (gauge) (400 psig) to about 20.7 MPa (gauge) (3000 psig), a liquid hourly space velocity (LHSV) from about 0.4 to less than about 2.5 hr⁻¹ and a hydrogen rate of about 337 Nm³/m³ (2,000 scf/bbl) to about 2,527 Nm³/m³ oil (15,000 scf/bbl).

The hydrocracked stream may exit the hydrocracking reactor 150 in a hydrocracked line 152. The hydrocracked stream in line 152 is combined with the hydroisomerized stream in line 50 to provide the hydroprocessed stream in line 54 and processed as previously described.

In the foregoing process, all of the reactor charge streams are heated to reaction temperature by heat exchange with the hydrotreated stream in line 32. Consequently, no fired heaters are required for heating pressurized reactor charge streams.

### Example

We simulated the disclosed process which employs no fired heaters to preheat feed to any of the reactors. The duty for each heater or exchanger is provided in the Table below. In the Table, reference numerals for the elements in the drawings are provided in parenthesis for each heater or exchanger in the drawing.

TABLE

| | Duty, MMBtu/hr | |
|---|---|---|
| Equipment | Base Case | Proposed Case |
| Combined Isomerization Feed Exchanger (34) | 7.5 | 11 |
| Hydrocracking Effluent Charge Exchanger (155) | 6 | 6 |
| Hydrotreating Charge Exchanger (22) | 39.9 | 44 |
| Hydrotreating Combined Feed Heater | 8.9 | 0 |
| Isomerization Feed Heater | 5.3 | 0 |

From the simulation, it is evident that all of the duty for preheating the feed to the isomerization reactor 48, the hydrotreating reactor 25 and the hydrocracking reactor 150 are provided by heat exchange with the hydrotreated stream in line 32. A hydrotreating combined feed heater and an isomerization feed heater which are fired heaters typically necessary in the conventional process are eliminated with their utilities by the disclosed process.

### SPECIFIC EMBODIMENTS

While the following is described in conjunction with specific embodiments, it will be understood that this description is intended to illustrate and not limit the scope of the preceding description and the appended claims.

A first embodiment of the invention is a process for hydroprocessing hydrocarbon streams comprising heating a hydrotreating charge stream by heat exchange with a hydrotreated stream to provide a heated hydrotreating charge stream; hydrotreating the heated hydrotreating charge stream in the presence of hydrogen over a hydrotreating catalyst to provide the hydrotreated stream; heating a hydroisomerization charge stream by heat exchange with the hydrotreated stream to provide a heated hydroisomerization charge stream; and hydroisomerizing the heated hydroisomerization charge stream in the presence of hydrogen over a hydroisomerization catalyst to provide a hydroisomerized stream. An embodiment of the invention is one, any or all of prior embodiments in this paragraph up through the first embodiment in this paragraph further comprising heating a hydrocracking charge stream by heat exchange with the hydrotreated stream to provide a heated hydrocracking charge stream and hydrocracking the heated hydrocracking charge stream in the presence of hydrogen to provide a hydrocracked stream. An embodiment of the invention is one, any or all of prior embodiments in this paragraph up through the first embodiment in this paragraph further comprising heating the hydrotreating charge stream without heating the hydrotreating charge stream in a fired heater. An embodiment of the invention is one, any or all of prior embodiments in this paragraph up through the first embodiment in this paragraph further comprising heating the hydrotreating charge stream only by heat exchange with the hydrotreated stream. An embodiment of the invention is one, any or all of prior embodiments in this paragraph up through the first embodiment in this paragraph further comprising heating the hydroisomerization charge stream without heating the hydroisomerization charge stream in a fired heater. An embodiment of the invention is one, any or all of prior embodiments in this paragraph up through the first embodiment in this paragraph further comprising heating the hydroisomerization charge stream only by heat exchange with another stream. An embodiment of the invention is one, any or all of prior embodiments in this paragraph up through the first embodiment in this paragraph further comprising heating the hydrocracking charge stream without heating the hydrocracking charge stream in a fired heater. An embodiment of the invention is one, any or all of prior embodiments in this paragraph up through the first embodiment in this paragraph further comprising heating the hydrocracking charge stream only by heat exchange with another stream. An embodiment of the invention is one, any or all of prior embodiments in this paragraph up through the first embodiment in this paragraph wherein the hydroisomerization charge stream is heated by heat exchange with the hydrotreated stream before the hydrotreating charge stream is heated by heat exchange with the hydrotreated stream with regard to the hydrotreated stream. An embodiment of the invention is one, any or all of prior embodiments in this paragraph up through the first embodiment in this paragraph wherein the hydroisomerization charge stream is heated by heat exchange with the hydrotreated stream before the hydrocracking charge stream is heated by heat exchange with the hydrotreated stream with regard to the hydrotreated stream. An embodiment of the invention is one, any or all of prior embodiments in this paragraph up through the first embodiment in this paragraph wherein the hydrocracking charge stream is heated by heat exchange with the hydrotreated stream before the hydrotreating charge stream is heated by heat exchange with the hydrotreated stream with regard to the hydrotreated stream. An embodiment of the invention is one, any or all of prior embodiments in this paragraph up through the first embodiment in this paragraph wherein hydrotreating the heated hydrotreating charge stream includes hydrotreating the hydrotreating charge stream in a guard reactor and in a hydrotreating reactor. An embodiment of the invention is one, any or all of prior embodiments in this paragraph up through the first embodiment in this paragraph wherein the hydrotreating charge stream is a fresh hydrocarbon stream. An embodiment of the invention is one, any or all of prior embodiments in this paragraph up through the first embodiment in this paragraph wherein the hydroisomerization charge stream is taken from the hydrotreated stream. An embodiment of the invention is one, any or all of prior embodiments in this paragraph up through the first embodiment in this paragraph wherein the hydrocracking charge stream is taken from the hydroisomerized stream.

A second embodiment of the invention is a process for hydroprocessing hydrocarbon streams comprising heating a hydrotreating charge stream by heat exchange with a hydrotreated stream to provide a heated hydrotreating charge stream; hydrotreating the heated hydrotreating charge stream in the presence of hydrogen over a hydrotreating catalyst to provide the hydrotreated stream; heating a hydroisomerization charge stream by heat exchange with the hydrotreated stream to provide a heated hydroisomerization charge stream; hydroisomerizing the heated hydroisomerization charge stream in the presence of hydrogen over a hydroisomerization catalyst to provide a hydroisomerized stream; heating a hydrocracking charge stream by heat exchange with the hydrotreated stream to provide a heated hydrocracking charge stream; and hydrocracking the heated hydrocracking charge stream in the presence of hydrogen to provide a hydrocracked stream. An embodiment of the invention is one, any or all of prior embodiments in this paragraph up through the second embodiment in this paragraph further comprising heating the hydrotreating charge stream, the hydroisomerization charge stream and the hydrocracking charge stream only by heat exchange with the hydrotreated stream.

A third embodiment of the invention is a process for hydroprocessing hydrocarbon streams comprising heating a hydrotreating charge stream by heat exchange with a hydrotreated stream to provide a heated hydrotreating charge stream; hydrotreating the heated hydrotreating charge stream in the presence of hydrogen over a hydrotreating catalyst to provide the hydrotreated stream; taking a hydroisomerization charge stream from the hydrotreated stream; heating the hydroisomerization charge stream by heat exchange with the hydrotreated stream to provide a heated hydroisomerization charge stream; and hydroisomerizing the heated hydroisomerization charge stream in the presence of hydrogen over a hydroisomerization catalyst to provide a hydroisomerized stream. An embodiment of the invention is one, any or all of prior embodiments in this paragraph up through the third embodiment in this paragraph further comprising taking a hydrocracking charge stream from the hydroisomerized stream; heating the hydrocracking charge stream by heat exchange with the hydrotreated stream to provide a heated hydrocracking charge stream and hydrocracking the heated hydrocracking charge stream in the presence of hydrogen to provide a hydrocracked stream. An embodiment of the invention is one, any or all of prior embodiments in this paragraph up through the third embodiment in this paragraph wherein the hydroisomerization charge stream is heated by heat exchange with the hydrotreated stream before the hydrocracking charge stream is heated by heat exchange with the hydrotreated stream and the hydrocracking charge stream is heated by heat exchange with the hydrotreated stream before the hydrotreating charge stream is heated by heat exchange with the hydrotreated stream with regard to the hydrotreated stream.

Without further elaboration, it is believed that using the preceding description that one skilled in the art can utilize the present disclosure to its fullest extent and easily ascertain the essential characteristics of this disclosure, without departing from the spirit and scope thereof, to make various changes and modifications of the disclosure and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

1. A process for hydroprocessing hydrocarbon streams comprising:
heating a hydrotreating charge stream by heat exchange with a hydrotreated stream to provide a heated hydrotreating charge stream;
hydrotreating said heated hydrotreating charge stream in the presence of hydrogen over a hydrotreating catalyst to provide said hydrotreated stream;
heating a hydroisomerization charge stream by heat exchange with said hydrotreated stream to provide a heated hydroisomerization charge stream; and
hydroisomerizing said heated hydroisomerization charge stream in the presence of hydrogen over a hydroisomerization catalyst to provide a hydroisomerized stream.

2. The process of claim 1 further comprising heating a hydrocracking charge stream by heat exchange with said hydrotreated stream to provide a heated hydrocracking charge stream and hydrocracking said heated hydrocracking charge stream in the presence of hydrogen to provide a hydrocracked stream.

3. The process of claim 1 further comprising heating said hydrotreating charge stream without heating said hydrotreating charge stream in a fired heater.

4. The process of claim 1 further comprising heating said hydrotreating charge stream only by heat exchange with said hydrotreated stream.

5. The process of claim 1 further comprising heating said hydroisomerization charge stream without heating said hydroisomerization charge stream in a fired heater.

6. The process of claim 1 further comprising heating said hydroisomerization charge stream only by heat exchange with another stream.

7. The process of claim 1 further comprising heating said hydrocracking charge stream without heating said hydrocracking charge stream in a fired heater.

8. The process of claim 1 further comprising heating said hydrocracking charge stream only by heat exchange with another stream.

9. The process of claim 1 wherein said hydroisomerization charge stream is heated by heat exchange with said hydrotreated stream before said hydrotreating charge stream is heated by heat exchange with said hydrotreated stream with regard to the hydrotreated stream.

10. The process of claim 2 wherein said hydroisomerization charge stream is heated by heat exchange with said hydrotreated stream before said hydrocracking charge stream is heated by heat exchange with said hydrotreated stream with regard to the hydrotreated stream.

11. The process of claim 2 wherein said hydrocracking charge stream is heated by heat exchange with said hydrotreated stream before said hydrotreating charge stream is heated by heat exchange with said hydrotreated stream with regard to the hydrotreated stream.

12. The process of claim 1 wherein hydrotreating said heated hydrotreating charge stream includes hydrotreating said hydrotreating charge stream in a guard reactor and in a hydrotreating reactor.

13. The process of claim 1 wherein the hydrotreating charge stream is a fresh hydrocarbon stream.

14. The process of claim 1 wherein said hydroisomerization charge stream is taken from said hydrotreated stream.

15. The process of claim 2 wherein said hydrocracking charge stream is taken from said hydroisomerized stream.

16. A process for hydroprocessing hydrocarbon streams comprising:
heating a hydrotreating charge stream by heat exchange with a hydrotreated stream to provide a heated hydrotreating charge stream;
hydrotreating said heated hydrotreating charge stream in the presence of hydrogen over a hydrotreating catalyst to provide said hydrotreated stream;
heating a hydroisomerization charge stream by heat exchange with said hydrotreated stream to provide a heated hydroisomerization charge stream;
hydroisomerizing said heated hydroisomerization charge stream in the presence of hydrogen over a hydroisomerization catalyst to provide a hydroisomerized stream;
heating a hydrocracking charge stream by heat exchange with said hydrotreated stream to provide a heated hydrocracking charge stream; and
hydrocracking said heated hydrocracking charge stream in the presence of hydrogen to provide a hydrocracked stream.

17. The process of claim 16 further comprising heating said hydrotreating charge stream, said hydroisomerization charge stream and said hydrocracking charge stream only by heat exchange with said hydrotreated stream.

18. A process for hydroprocessing hydrocarbon streams comprising:
heating a hydrotreating charge stream by heat exchange with a hydrotreated stream to provide a heated hydrotreating charge stream;
hydrotreating said heated hydrotreating charge stream in the presence of hydrogen over a hydrotreating catalyst to provide said hydrotreated stream;
taking a hydroisomerization charge stream from said hydrotreated stream;
heating said hydroisomerization charge stream by heat exchange with said hydrotreated stream to provide a heated hydroisomerization charge stream; and
hydroisomerizing said heated hydroisomerization charge stream in the presence of hydrogen over a hydroisomerization catalyst to provide a hydroisomerized stream.

19. The process of claim 18 further comprising taking a hydrocracking charge stream from said hydroisomerized stream; heating said hydrocracking charge stream by heat exchange with said hydrotreated stream to provide a heated hydrocracking charge stream and hydrocracking said heated hydrocracking charge stream in the presence of hydrogen to provide a hydrocracked stream.

20. The process of claim 19 wherein said hydroisomerization charge stream is heated by heat exchange with said hydrotreated stream before said hydrocracking charge stream is heated by heat exchange with said hydrotreated stream and said hydrocracking charge stream is heated by heat exchange with said hydrotreated stream before said hydrotreating charge stream is heated by heat exchange with said hydrotreated stream with regard to the hydrotreated stream.
